(19) United States
(12) Patent Application Publication
(10) Pub. No.: US 2026/0150832 A1
(43) Pub. Date: Jun. 4, 2026

(54) ORGAN PRESERVATION DEVICE

(71) Applicant: The Regents of the University of California, Oakland, CA (US)

(72) Inventors: Peter Than, San Diego, CA (US); Aleah L. Brubaker, San Diego, CA (US); Maziar Ghazinejad, San Diego, CA (US); Victor Leung, San Diego, CA (US); Ethan Kozberg, Granada Hills, CA (US); Joseph Elhardt, San Diego, CA (US); Manuel Abita Leon, San Diego, CA (US); Ngoc Duyen Thi Nguyen, Hawthorne, CA (US)

(21) Appl. No.: 19/389,526

(22) Filed: Nov. 14, 2025

Related U.S. Application Data
(60) Provisional application No. 63/728,064, filed on Dec. 4, 2024.

(51) Int. Cl. A01N 1/143; A01N 1/144

(52) U.S. Cl. CPC A01N 1/143; A01N 1/144

(57) ABSTRACT

A system for ex vivo normothermic organ preservation may include a pump configured to circulate a perfusate through a perfusion circuit, an oxygenator coupled configured to oxygenate the perfusate, a heat exchanger configured to regulate a temperature of the perfusate and an organ chamber having an internal volume configured to receive an organ. The perfusion circuit may be configured to be coupled in fluid communication with an arterial inlet into the organ. The system may also include a processor and memory having instructions that when executed by the processor cause the system to carry out a method. The method may include changing a temperature of the perfusate from an initial temperature to a normothermic temperature within a normothermic temperature range, maintaining the perfusate within the normothermic temperature range for at least one hour, receiving sensor data for perfusate parameters, and displaying the sensor data.

### RELATED APPLICATIONS

This application claims the benefit under 35 U.S.C. § 119(e) of U.S. Provisional Ser. No. 63/728,064 , filed Dec. 4, 2024, which is incorporated herein, in its entirety, by this reference.

### BACKGROUND

Kidney transplantation is the gold standard treatment for patients suffering from end-stage renal disease (ESRD) with marked improvements in patient survival, quality of life, and healthcare cost compared to maintenance dialysis. However, the severe shortage of donor organs has resulted in a waiting list of over 90,000 patients awaiting kidney transplantation in the U.S. alone, with nearly 9,000 patients removed from the waiting list yearly due to death or becoming too sick for transplant. The primary method used for preserving kidneys since the 1960s has been cold storage using ice. While this method is easy to implement, it allows for ongoing low-level cellular metabolism, leading to the gradual deterioration of kidney tissue during this state of ischemia, or lack of oxygenated blood flow. As a result, there is a limited time period in which a kidney remains viable for transplantation, and this modality affords no metabolic recovery of the organ or opportunity for functional assessment. These limitations of cold preservation combined with medical and logistical complexity and organ allocation policies result in an exceedingly high rate of deceased donor kidney discard, about 28% or 6,000 kidneys annually.

All transplanted organs experience ischemia-reperfusion injury (IRI), which is caused by the restoration of blood flow after a period of ischemia, resulting in a cascade of oxidative and inflammatory mediated tissue damage that may lead to organ allograft dysfunction. Kidneys with prolonged cold preservation as well as kidneys from expanded criteria donors (ECD), including older donors or those after circulatory death, are particularly vulnerable to IRI-mediated dysfunction, with up to 50% of recipients requiring dialysis after transplant.

### SUMMARY

To address these shortcomings, an NMP device is developed and demonstrated. The device is shown to meet the physiological needs of a human kidney. A proof-of-concept experiment with perfusion of human kidneys is performed on a device developed in relation to this disclosure and showed sustained kidney function over an hour of perfusion, evidenced by maintenance of physiological perfusate flow rate, pressure, temperature, and urine production.

In some example embodiments, there may be provided systems, methods, and articles of manufacture for an organ preservation device.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a block diagram of an organ preservation system, in accordance with some embodiments

FIG. 2 depicts a simplified diagram of an organ preservation system, in accordance with some embodiments.

FIG. 3 depicts aspects of an experimental setup of a normothermic machine perfusion device, in accordance with some embodiments.

FIG. 4 depicts a table of perfusate contents used in experimental testing of the organ preservation system, in accordance with some embodiments.

FIG. 5 depicts a table of perfusate measurements from experimental testing of the organ preservation system, in accordance with some embodiments.

FIG. 6 depicts a method of using the organ preservation system, in accordance with some embodiments.

FIG. 7 depicts a method of using the organ preservation system, in accordance with some embodiments.

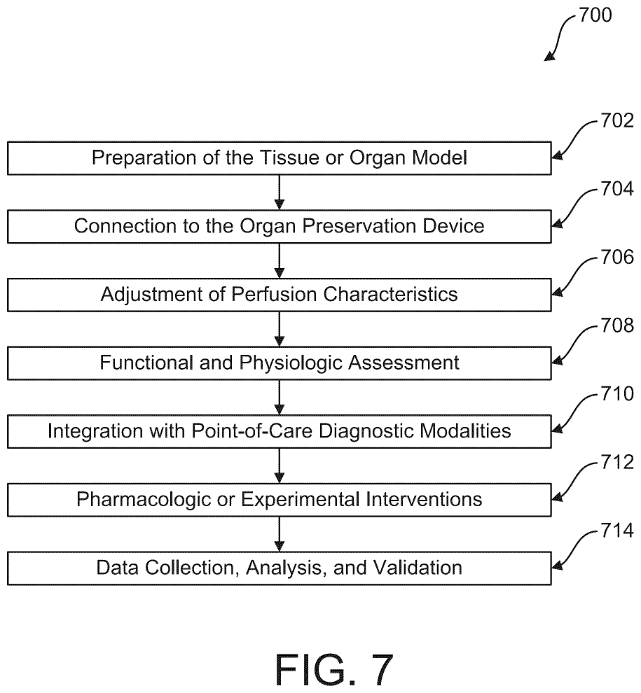

### DETAILED DESCRIPTION

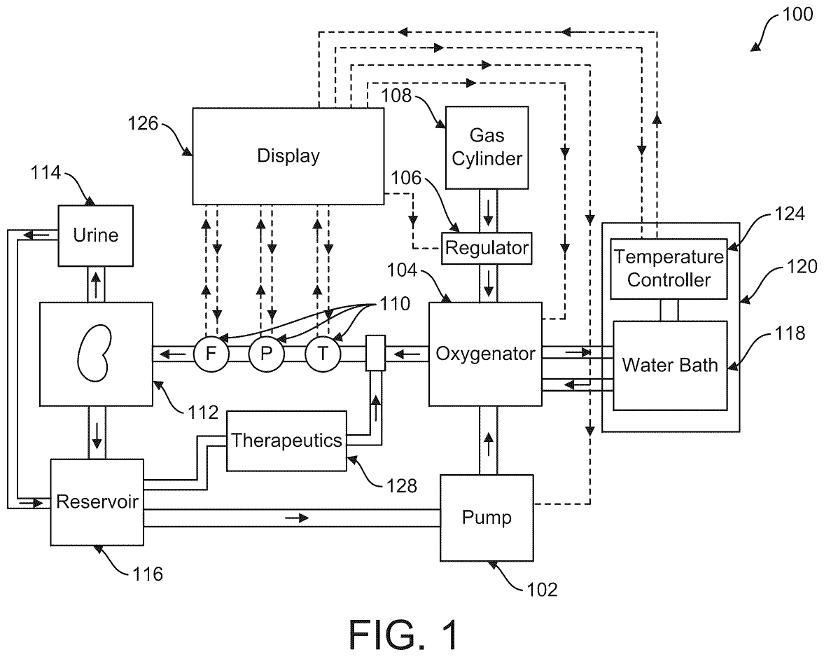

FIG. 1 depicts a block diagram of an organ preservation device 100, in accordance with some embodiments. The organ preservation device may include a pump 102. The pump 102 may be a pulsatile or continuous pump. The pump 102 circulates perfusate through the entire device.

The organ preservation device 100 may utilize various perfusate formulations depending on the application, duration of perfusion, and desired metabolic activity of the organ. Suitable perfusates may include whole blood, packed red blood cells (pRBCs), or cell-free oxygen carriers such as hemoglobin-based oxygen-carrying (HBOC) solutions. In some embodiments, formulations may employ colloid-based solutions containing albumin or dextran to maintain oncotic pressure, or crystalloid solutions supplemented with electrolytes, glucose, and amino acids to support cellular metabolism. The perfusate may also contain antioxidants, vasodilators, antibiotics, and other additives to promote physiologic function and reduce ischemic injury during normothermic organ preservation.

The pump 102 may be configured to move perfusate from the reservoir through the oxygenator and into the arterial conduit supplying the organ. The pump may be of any type capable of generating physiologic flow and pressure compatible with organ perfusion. Suitable pumps include pulsatile pumps, such as peristaltic roller pumps or diaphragm pumps, and continuous-flow pumps, such as centrifugal and in some embodiments, gear pumps, which may be suitable for non-blood perfusate.

In some embodiments, a pulsatile roller pump may be used to simulate the rhythmic output of a human heart. The roller pump comprises a rotating head carrying one or more rollers that compress flexible tubing against a curved housing. As the head turns, the rollers sequentially occlude and release the tubing, producing a forward displacement of perfusate and generating discrete pulses of flow. By adjusting the rotational speed and tubing diameter, the system can achieve flow profiles approximating physiologic cardiac output, including systolic, diastolic, and mean arterial pressures within a desired range. The pulsatile action promotes physiologic flow dynamics beneficial for maintaining vascular integrity and tissue perfusion during ex vivo perfusion.

In some embodiments, the flow dynamics of the perfusate within the organ preservation device 100 may be modulated by controlling one or more variables, including pump flow rate, tubing stiffness, and external tubing compression. These parameters may be adjusted individually or in combination to simulate physiologic arterial pressure profiles and shear forces experienced by the organ in vivo.

The pump flow rate may be varied through the controller 126 to produce either continuous or pulsatile flow. By adjusting the pump's rotational speed, stroke volume, or duty cycle, the system can generate perfusion waveforms that replicate physiologic systolic and diastolic phases, achieving mean arterial pressures within desired ranges (for example, 60-80 mmHg). Modulation of the pump output allows fine-tuning of flow pulsatility, frequency, and amplitude, thereby influencing endothelial shear stress and perfusion homogeneity within the organ.

The stiffness and compliance of the perfusion tubing may also be selected or adjusted to influence the damping characteristics of the flow circuit. Without being limited by theory, more compliant tubing materials, such as silicone or thermoplastic elastomers, may absorb part of the pressure pulse, resulting in smoother, less pulsatile flow, whereas stiffer tubing, such as reinforced polyurethane or fluoropolymer, may provide a greater amplitude of the pressure waveform generated by the pump. Strategic placement of compliant or rigid segments within the circuit enables tailored pressure—flow relationships that mimic physiologic vascular compliance.

Additionally, external tubing compression mechanisms, such as adjustable clamps, peristaltic roller tensioners, or mechanical pinch valves, may be employed to regulate localized flow resistance and to fine-tune the magnitude of pulsation transmitted to the organ. Controlled compression of the arterial line can dampen excessive peaks or simulate physiologic vascular resistance, while release of compression restores higher flow rates.

Alternatively, a centrifugal pump may be employed to provide continuous non-pulsatile flow. In this configuration, a rotating impeller imparts kinetic energy to the perfusate, creating a smooth, continuous flow with minimal mechanical trauma to blood or perfusate components. Centrifugal pumps offer precise flow control, rapid response to resistance changes, and reduced hemolysis relative to positive-displacement designs. Though, in some embodiments, a positive-displacement pump may be used.

The pump 102 inlet may be hydraulically coupled to the reservoir, drawing perfusate through a suction line or pickup port located below the fluid surface. The pump outlet is coupled to the oxygenator inlet, directing pressurized flow through the heat exchanger and gas exchange module before reaching the arterial conduit that supplies the organ. Check valves or clamps may be positioned at the inlet and outlet to prevent backflow during priming or shutdown. The arrangement allows circulation of perfusate through the circuit while maintaining controlled flow, pressure, and temperature to the organ.

The organ preservation device 100 may include an oxygenator 104. The oxygenator allows for the gas exchange of oxygen into and carbon dioxide out of the perfusate. Air emboli are filtered from the perfusate. An integrated heat exchanger provides for efficient temperature regulation of the perfusate.

The oxygenator 104 receives perfusate from the outlet of pump 102 and serves multiple integrated functions: gas exchange, temperature regulation, and air removal. In some embodiments, the oxygenator includes a hollow-fiber membrane module through which perfusate flows on the outside of semi-permeable fibers while a controlled gas mixture, typically oxygen or carbogen (95% O₂/5% CO₂), flows within the fibers. Oxygen diffuses across the fiber membranes into the perfusate, while carbon dioxide diffuses in the opposite direction. This arrangement maintains physiologic dissolved oxygen levels and pH balance in the circulating fluid.

The oxygenator may incorporate or be thermally coupled to a heat exchanger that regulates the temperature of the perfusate, such as to maintain the organ at approximately 35-38° C. or to ramp the temperature up or down from an initial temperature, such as a temperature of the organ after hypothermic or subnormothermic storage, to human body temperature or in the other direction. The heat exchanger may utilize a circulating water bath, electrical resistance elements, or thermoelectric modules to transfer heat to the perfusate, such as through a conductive metal housing surrounding the perfusate path. In integrated embodiments, the oxygenator and heat exchanger are combined in a single cartridge, allowing compact design and reduced priming volume. In alternative configurations, the heat exchanger may be a distinct unit upstream or downstream of the oxygenator, allowing independent control of thermal and gas exchange parameters or redundancy in temperature control.

As perfusate exits the oxygenator, it passes through a bubble trap or air-separation chamber that removes entrained gas or microemboli generated during gas exchange or handling. This step aides in degassing the perfusate so that degassed, oxygenated, and temperature-stabilized perfusate exits the oxygenator and reaches the arterial conduit leading to the organ. Check valves and pressure relief mechanisms may be provided to maintain unidirectional flow and prevent accidental overpressurization of the oxygenator. The combined function of heating, oxygenating, and degassing provides physiologic-quality perfusate to the organ that supports metabolism and reduces the risk of vascular injury.

The organ preservation device 100 may include a regulator 106. The regulator may be used to controls the flow of gas from the gas cylinder 108. The regulator 106 controls the flow and pressure of gas delivered from the gas cylinder 108 to the oxygenator 104. In one embodiment, the regulator comprises a dual-stage pressure control assembly including a primary stage that reduces the high cylinder pressure (for example, 2,000-3,000 psi) to an intermediate level, and a secondary stage that provides fine adjustment of the outlet pressure and flow rate. The regulator outlet may connect to a flowmeter or gas blender that mixes oxygen with carbon dioxide or air to achieve a desired concentration for the oxygenator's gas inlet.

The regulator may incorporate a pressure gauge or pressure sensor on both the high-pressure and low-pressure sides to allow monitoring of cylinder contents and delivery pressure. A needle valve or rotameter may be used to adjust the flow rate precisely, enabling accurate control of gas exchange within the oxygenator. In some embodiments, the regulator includes solenoid or electronic valves governed by the system controller, allowing automated modulation of gas flow in response to measured perfusate oxygen or pH.

In operation, the regulator provides a continuous, stable supply of oxygen or other therapeutic gas mixtures to the oxygenator, maintaining physiologic gas exchange conditions while reducing risk of pressure spikes or flow interruption.

In some embodiments, the system may include a plurality of regulators, one or more for each gas to be provided into the perfusate.

The organ preservation device 100 may include a gas supply or source 108, which may include a gas cylinder. The gas supply 108 may provide either medical grade oxygen gas or gas mixture. The gas supply 108 provides the source of oxygen or other gas mixtures for perfusate oxygenation and pH control. In some embodiments, the gas supply is a high-pressure medical-grade gas cylinder equipped with a standardized valve fitting compatible with the regulator 106. The cylinder may contain pure oxygen, medical air, or a blended gas mixture, such as 95% oxygen and 5% carbon dioxide, which helps maintain physiologic acid-base balance within the perfusate. In some applications, nitrogen or nitric oxide mixtures may be used to modulate vasoreactivity or simulate physiologic gas conditions.

The gas cylinder may be constructed of steel, aluminum, or composite material and may be rated for pressures up to about 2,000-3,000 psi. The outlet of the gas supply connects securely to the inlet of the regulator 106. Downstream of the regulator, the gas may flow through a flowmeter or gas blender before entering the oxygenator 104.

In other embodiments, the gas supply may be provided by a centralized wall-mounted medical gas system, a portable oxygen concentrator, or a cartridge-based disposable gas source, allowing adaptability to clinical, laboratory, or field environments. Safety features such as check valves, pressure relief mechanisms, and color-coded hoses may be used to prevent accidental misconnection or backflow. A pressure gauge or sensor on the cylinder or regulator provides real-time indication of remaining gas volume.

Together with the regulator and oxygenator, the gas supply 108 may provide a reliable and controllable delivery of oxygen and other gases to maintain metabolic activity of the perfused organ under normothermic conditions.

The organ preservation device 100 may include one or more sensors, such as at least one sensor 110. The at least one sensor may include a flow sensor (F), a pressure sensor (P), and/or a temperature sensor (T) of the perfusate prior to entering the organ, such as a kidney, wherein any sensor measurements are measured and sent to a display and/or a controller. In some embodiments, sensors 110 may be incorporated throughout the organ preservation device 100 to monitor physiologic and mechanical parameters of the perfusion process. Examples include microdialysis needles to measure metabolic and physiologic function within the organ, perfusate assessment using flow cytometry, multi-plex polymerase chain reaction, and other techniques to evaluate organ function and quality.

The flow sensor may be an ultrasonic type sensor positioned in the arterial conduit to provide real-time measurement of volumetric flow rate, allowing precise control of perfusion dynamics. The pressure sensor may be a solid-state transducer or fluid-filled diaphragm gauge located proximal to the arterial cannula to measure perfusion pressure delivered to the organ, and additional pressure sensors may be positioned at the venous outflow or within the reservoir to monitor return pressure and ensure proper drainage. In some embodiments, the sensor may be an electromagnetic or turbine-type sensor, such as, for example, when using non-blood perfusate.

The temperature sensor may be a thermocouple, thermistor, or infrared probe that measures perfusate temperature at multiple locations, such as within the arterial line before the organ, at the surface of the organ within the chamber, and within the reservoir. These readings verify that the perfusate and the organ remain within a physiologic thermal range, which may be between 35 and 38° C., and can trigger automatic adjustments by the controller to maintain temperature stability.

In some embodiments, the system may include additional including oxygen sensors, such as Clark-type electrodes or optical fluorescence sensors, to measure dissolved oxygen tension (pO₂) in the perfusate, and carbon dioxide sensors to monitor pCO₂ for acid-base regulation. pH sensors, electrical conductivity probes, and ion-selective electrodes may also be incorporated to measure electrolytes and metabolic waste levels. In some embodiments, optical or spectrophotometric sensors may measure perfusate hemoglobin saturation or detect the presence of therapeutic agents.

In some embodiments, measurement locations may include the reservoir to assess perfusate composition, in the urine collection line to evaluate urine output volume and composition, and within the organ chamber to record ambient temperature and humidity. Weight or load-cell sensors beneath the organ chamber or urine bag may provide automated urine output measurements. In more advanced embodiments, miniature pressure catheters or microelectrodes may be inserted into the organ parenchyma to monitor intrarenal perfusion pressure, tissue oxygenation, or metabolic, transcriptional, or proteomic markers.

Sensor outputs may be transmitted to a controller or data acquisition module and displayed on a graphical user interface, where parameters such as flow, pressure, temperature, oxygen saturation, and urine production are displayed in real time. The controller may log all sensor data for post-perfusion analysis, system diagnostics, and integration with external monitoring software.

The organ preservation device 100 may include an organ chamber 112. The chamber 112 may contain an organ or portion of an organ, such as kidney remains, where the kidney or other organ rests on for example a soft, fenestrated platform to allow for drainage of perfusate to the reservoir 116. One or more ports on the chamber may be used to provide one or more connections of medical-grade tubing to renal blood vessels, perfusate drainage, and/or the ureter for urine collection. The vein may be left open to the atmosphere of the chamber, and the chamber may be configured to funnel or otherwise drain venous effluent to a central reservoir.

In some embodiments, the organ chamber 112 may be constructed as a transparent enclosure formed of medical-grade materials such as polycarbonate allowing visual inspection of the organ during perfusion. The chamber may be cylindrical, oval, or rectangular in shape and may include a removable lid or hinged cover to facilitate sterile placement and retrieval of the organ. The chamber interior may be configured to be a humidified, thermally stable microenvironment, and may be covered to minimize evaporative cooling and contamination.

A platform may support the organ. The platform may be a fenestrated platform may be formed of compliant material, such as silicone or polyurethane. In some embodiments, the platform includes a soft elastomeric surface or a mesh insert that distributes the organ's weight evenly, preventing compression or focal ischemia of the underlying tissue. The perforations or mesh openings allow perfusate and venous effluent to drain freely to the bottom of the container and then into the reservoir 116.

In some embodiments, the organ chamber may incorporate built-in drainage channels or a sloped floor that funnels effluent toward a central outlet port to aid collection of perfusate and urine. The chamber may also include one or more side ports or top fittings for connection of medical-grade tubing that carries the arterial inflow line, venous outflow, ureteral drainage, and temperature or oxygen probes. These ports may use luer lock couplings, barbed fittings, or quick-connect couplings for secure, sterile attachment and easy disassembly for cleaning or replacement.

The chamber may be designed as a single-use disposable cartridge or as a reusable component with smooth, nonporous internal surfaces that tolerate repeated sterilization by autoclaving or chemical disinfection. The chamber may include mounting brackets, clamps, or adjustable supports that stabilize the organ cannulas and maintain proper alignment of the arterial and ureteral connections. In some embodiments, heating elements or fluid jackets may surround the chamber to maintain uniform temperature distribution independent of the perfusate temperature.

Sensors such as temperature probes, humidity sensors, and optical detectors may be embedded in or on the chamber walls to provide continuous feedback on environmental conditions. The transparent nature of the chamber enables visual assessment of perfusion quality, color, and turgor of the organ parenchyma, and may also accommodate imaging or illumination modules, such as LED light sources or small cameras, to document perfusion in real time.

In some embodiments, the chamber may be adapted for use with organs of varying size and morphology, such as livers, hearts, or composite tissue grafts. For example, interchangeable platform inserts or adjustable retaining rings may accommodate different anatomical structures. In multi-organ systems, two or more chambers may share a common reservoir, each with independent inflow control, allowing simultaneous perfusion of paired organs such as kidneys.

The organ preservation device 100 may include a urine collection device 114, which may be a urine reservoir, and/or may be configured to carry urine 114 to the reservoir 116. The urine may be collected by cannulating the ureter and draining either into the urine collection device 114 for measurement, directly back into the reservoir 116, or into the urine collection device 114 for measurements before transportation to the reservoir 116 for replacement and recirculation in the perfusate.

In certain embodiments, the urine collection device 114 is configured to receive and measure urine output from the perfused organ, such as a kidney, during normothermic perfusion. The device may include a transparent graduated chamber, collection bag, or rigid container that allows direct visualization and quantification of urine production in real time. The collection device may be fabricated from medical-grade polyvinyl chloride (PVC), polyethylene, polypropylene, or silicone, all of which are biocompatible and suitable for contact with perfusate and biological fluids.

The ureter of the organ may be cannulated using a flexible catheter or stent, which connects through sterile medical-grade tubing to the inlet of the urine collection device. The tubing may include a one-way valve or clamp to prevent backflow and to allow intermittent sampling of urine for biochemical analysis. The graduated volume markings on the device enable continuous monitoring of urine production, an important indicator of renal viability and glomerular filtration function.

In some embodiments, the urine collection device 114 is positioned below or adjacent to the reservoir 116, allowing urine to flow by gravity through a secondary drain line into the reservoir after measurement. In another embodiment, urine is collected in an intermediate chamber where its volume and properties, such as color, clarity, and pH, can be assessed before the fluid is directed to the reservoir. Automated versions of the device may incorporate optical or ultrasonic level sensors that continuously monitor urine volume and transmit data to the controller, providing an accurate urine output rate without manual measurement.

The urine collection device may also be equipped with sampling ports, valved access fittings, or removable caps that allow sterile withdrawal of urine for laboratory testing. Sensors located within the urine collection line or chamber may measure temperature, conductivity, or concentration of metabolites such as creatinine, glucose, and electrolytes, allowing continuous biochemical assessment of renal function during perfusion.

In some embodiments, the urine collection device may include a microfluidic or cartridge-based analysis module integrated into the urine outlet line, enabling automated testing of biomarkers such as KIM-1 (Kidney Injury Molecule-1), NGAL (Neutrophil Gelatinase-Associated Lipocalin), and other viability markers. These real-time measurements can be transmitted to the controller and recorded along with other perfusion parameters for comprehensive data analysis.

The urine collection device 114 may be designed as a single-use sterile disposable component that can be replaced between perfusion sessions, or as a reusable unit with smooth, autoclavable surfaces for laboratory applications. The device may also be mounted on a weighing platform or load cell to determine urine output by mass rather than volume, providing a precise, automated means of output quantification.

The organ preservation device 100 may include a reservoir 116. For example, perfusate from the kidney is collected and filtered in the reservoir and recirculated by the pump 102. Therapeutics can be added through the ports and perfusate samples can be taken to monitor kidney functions.

In some embodiments, the reservoir 116 functions as both a collection basin for venous effluent and a supply reservoir for recirculating perfusate. The reservoir may be positioned directly beneath the organ chamber 112 so that venous outflow and excess perfusate drain by gravity into the reservoir. The reservoir may be fabricated from biocompatible, transparent materials, such as polycarbonate or medical-grade stainless steel, allowing the operator to visually confirm fluid level, color, and presence of bubbles. The interior volume may be configured to hold sufficient perfusate, such as between 0.1 L to 1.5 L, to accommodate flow dynamics and aid in preventing cavitation at the pump inlet.

The reservoir 116 may include graduated markings for measuring total perfusate volume, a removable lid to minimize evaporation and contamination, and one or more access ports for sampling or infusion of therapeutic agents. The outlet of the reservoir may be hydraulically coupled to the inlet of the pump 102 via flexible medical-grade tubing, forming a continuous circulation loop. A suction pickup tube or bottom outlet port may aid with consistent withdrawal of perfusate while reducing or mitigating the introduction of air. In some embodiments, coarse filters or mesh screens may be integrated into the outlet line to aid in preventing debris or clots from entering the pump.

In some embodiments, the reservoir includes baffles or internal flow diffusers that reduce turbulence and promote uniform mixing of the perfusate. Temperature probes may be positioned within the reservoir to monitor the perfusate temperature. The reservoir can also include sensors such as oxygen sensors, pH electrodes, and conductivity probes for continuous assessment of perfusate composition and quality.

The organ preservation device 100 may include a water bath 118. The water bath is precisely temperature controlled and holds the fluid that is pumped through the heat exchanger 120 to facilitate perfusate temperature maintenance.

The organ preservation device 100 may include a water bath 118 configured to assist in maintaining the temperature of the perfusate and the organ at physiologic levels during normothermic perfusion. The water bath 118 may serve as the primary or supplementary heat exchange system, operating in conjunction with, or independently from, the heat exchanger integrated into the oxygenator 104.

In one embodiment, the water bath 118 comprises an insulated reservoir or circulation system that holds a volume of temperature-controlled water or heat transfer fluid. The bath may be equipped with electrical resistance heating elements, thermoelectric (Peltier) devices, or recirculating heat exchangers connected to an external heating and cooling unit. A precision temperature controller continuously monitors and adjusts the bath temperature to maintain a target range of at or around 38° C., such as approximately 35° C. to 38° C., thereby replicating physiologic conditions for the perfused organ.

The water bath 118 may be thermally coupled to one or more components of the perfusion circuit. In one configuration, coiled tubing or heat exchange loops carrying perfusate are immersed directly in the water bath, enabling efficient conductive heat transfer to the perfusate before it enters the organ. Alternatively, the water bath may circulate its heated fluid through an external jacket or manifold that surrounds the oxygenator 104, the organ chamber 112, or the reservoir 116, maintaining consistent temperature throughout the system.

In certain embodiments, the water bath may incorporate a submersible pump that continuously circulates water around the perfusate tubing or organ chamber jacket to prevent temperature stratification. Temperature probes or thermistors positioned at both the inlet and outlet of the perfusate path may feed data back to the main controller, enabling automated feedback control of heating or cooling cycles.

The water bath 118 may be constructed from stainless steel, anodized aluminum, or heat-resistant polymer materials such as polycarbonate or polypropylene. The bath is preferably insulated to minimize heat loss and may include a transparent cover or hinged lid to prevent evaporation and contamination. Safety features may include over-temperature cutoffs, low-water level sensors, and alarm systems that alert the operator to deviations from the set temperature range.

In some embodiments, the water bath may provide active cooling, allowing temperature adjustments for controlled rewarming protocols following hypothermic or sub-zero preservation and controlled cooling protocols for entering hypothermic or sub-zero preservation. The bath may be interfaced with the system's controller and display to provide real-time readouts of water temperature, heater status, and energy consumption.

The organ preservation device 100 may include a heat exchanger 120. The heat exchanger 120 may be similar to the heat exchanger discussed above. The heat exchanger 120 may include a temperature controller 124 and the water bath 118. The water bath temperature is controlled by the temperature controller which may include heating or cooling circuits and/or devices that that can heat or cool the water in the water bath 112 along with temperature, flow, and/or other sensors to measure the water bath and other temperatures.

In certain embodiments, the heat exchanger 120 functions as a thermal regulation unit for the perfusate and may operate in coordination with or independently from the oxygenator's integrated heat exchange system, as discussed herein. The heat exchanger 120 may include a temperature controller 124 and a water bath 118 forming a closed-loop system that maintains the perfusate and organ at physiologic temperature during normothermic operation.

The temperature controller 124 may include one or more heating and cooling circuits that use electrical resistance heaters, Peltier thermoelectric elements, or recirculating liquid heat exchangers. These components may be governed by an internal feedback loop linked to temperature, flow, and pressure sensors within the water bath 118 and the perfusion circuit. The controller can dynamically adjust heating or cooling rates to maintain a stable setpoint, such as 35° C. to 38° C. for normothermic preservation, or lower setpoints when used for hypothermic or rewarming stages.

The water bath 118 serves as the thermal transfer medium for the heat exchanger. The bath may contain distilled water or a biocompatible heat transfer fluid, and may be housed in an insulated stainless-steel or polymer vessel with a circulation pump that ensures uniform temperature distribution. The perfusate may be routed through coiled tubing or a plate-style exchanger immersed in the water bath, allowing conductive heat transfer without direct contact between the water and perfusate.

In some embodiments, the water bath 118 is hydraulically coupled with a heat exchanger within the oxygenator and circulates heated or cooled water through an external jacket or manifold surrounding or within the oxygenator 104. In some embodiments, perfusate from the oxygenator flows though the water bath and back into the oxygenator before being sent to the organ. In some embodiments, the heat exchanger may also provide heating and/or cooling to the reservoir and/or the chamber 112 to provide distributed thermal regulation across multiple system components. Flow rate through the heat exchanger may be controlled by the temperature controller 124 or an independent pump to fine-tune the rate of heat exchange in response to changing perfusate demand.

The heat exchanger assembly may also include temperature sensors positioned at the inlet and outlet of the perfusate loop to measure heat exchange efficiency. These readings are transmitted to the main system controller, which may adjust the operation of both the heat exchanger 120 and the oxygenator's heat exchange circuit to ensure precise temperature regulation.

Safety and redundancy features may include over-temperature protection, low-water level detection, and automatic shutdown in the event of overheating, pump failure, or thermal imbalance. In some embodiments, the temperature controller 124 may communicate digitally with the system's main processor to log temperature data, support preprogrammed temperature ramps (such as controlled rewarming after hypothermic perfusion), and provide visual and audible alerts when temperature deviations occur.

The organ preservation device 100 may include a display and/or control system 126. The display may present, for example, sensor data for a user to monitor system performance. The control system may include a processor and memory comprising instructions to carry out any of the methods described herein and may be used to for example regulate the temperature, pressure, and/or flow profiles of the perfusate as well as the flow rate of the gas mixture.

In some embodiments, the display and/or control system 126 provides centralized coordination, automation, and user feedback for the organ preservation device 100. The control system may include a microprocessor-or microcontroller-based architecture with associated memory, input/output interfaces, and communication circuitry. The processor may execute control algorithms that receive input signals from sensors monitoring flow, pressure, temperature, oxygen concentration, gas flow rate, and urine output, and may automatically adjust system actuators, such as the pump 102, regulator 106, oxygenator 104, and heat exchanger 120, to maintain user-defined setpoints.

The control system may implement feedback control logic, such as proportional-integral-derivative (PID) loops, to regulate perfusate flow and pressure within physiologic ranges (for example, mean arterial pressure between about 60 and 80 mmHg and flow between about 400 and 600 mL/min). Temperature feedback from sensors in the perfusate circuit, reservoir 116, and water bath 122 may be processed in real time to drive heating or cooling circuits. Gas flow and composition can likewise be adjusted by controlling solenoid valves or flow controllers on the gas supply 108 and regulator 106 based on measured oxygen saturation, pO2, pCO2, or pH of the perfusate.

The display interface may include a touchscreen graphical user interface (GUI) that presents real-time system parameters numerically and/or graphically. Parameters shown may include perfusate flow (mL/min), pressure (mmHg), temperature (° C.), oxygen concentration (mmHg or %), gas flow rate (L/min), urine output rate (mL/hr), accumulated volume (mL) and system status indicators such as pump speed, heater power, and alarm conditions. The display may also present trend graphs, color-coded warnings, and audible or visual alarms to alert the operator to deviations from programmed limits.

In some embodiments, the control system 126 may include preset operating modes or protocol templates, such as “Normothermic Perfusion,” “Hypothermic Perfusion,” “Controlled Rewarming,” or “Therapeutic Infusion,” each with predefined parameter profiles. The user may adjust parameters manually via touchscreen controls, physical dials, or software inputs, or may rely on automated closed-loop control. A data logging subsystem may record sensor readings, system settings, and alarm events to internal or removable memory for post-procedure analysis or regulatory documentation.

The control system 126 may communicate with peripheral components via wired or wireless interfaces, including USB, Ethernet, Bluetooth, or Wi-Fi, to enable remote monitoring and control or integration with laboratory information systems. In some embodiments, a remote monitoring application may display the same interface on a tablet, computer, or mobile device, allowing off-site supervision of ongoing perfusion.

In some embodiments, the organ preservation device 100 may include a remote monitoring and control subsystem that enables real-time observation and adjustment of kidney perfusion and viability from a remote location. The subsystem may provide a data link transmitting sensor readouts, perfusion parameters, and live video feed of the organ chamber 112 to a remote display or computing device. Users may access the system through a web-based or networked interface to review flow, pressure, temperature, oxygenation, and urine output data in real time. The same interface may accept remote input commands allowing adjustment of perfusion characteristics, such as pump speed, gas flow, or temperature setpoints, and control of the therapeutics module 128 for medication or gene therapy delivery. This remote capability enables continuous supervision of organ viability, supports expert consultation, and facilitates automated or human-in-the-loop adjustments during extended perfusion or transport.

Safety and reliability features of the controller may include redundant processors or watchdog circuits, automatic fail-safe shutdowns in the event of overpressure, overheating, or pump malfunction, and battery backup power to preserve data and maintain operation during temporary power loss. The controller may also perform self-diagnostic checks at startup to verify sensor calibration, valve operation, and communication integrity before initiating perfusion.

In some embodiments, the control system 126 may support adaptive or predictive control algorithms that analyze sensor trends to anticipate changes in vascular resistance or metabolic activity of the organ, adjusting flow of therapeutics, perfusates, and/or other parameters, such as temperature or oxygen delivery. The system may also interface with optical or biochemical sensors to integrate perfusate analytics, such as lactate, glucose, and electrolyte concentrations, into the automated control scheme to make control decisions and changes based on the sensor data.

In some embodiments, the controller 126 and associated system components may be equipped with or connected to a battery backup power source to enable portable operation of the organ preservation device 100. The battery system may provide sufficient capacity to maintain continuous perfusion, oxygenation, and temperature control for extended periods, allowing transport of the perfused organ between locations, such as from a donor hospital to a recipient hospital, without interruption. The device may automatically switch between AC mains power and battery power to ensure seamless operation during transport or in the event of a power failure. The power management circuitry may monitor battery charge status and prioritize essential subsystems, including the pump 102, oxygenator 104, controller 126, and temperature control elements. This portable power capability allows the system to be deployed directly at donor hospitals for organ retrieval and to maintain physiologic perfusion throughout transportation, thereby preserving organ viability until transplantation.

The organ preservation device 100 may include or used to provide one or more therapeutics module 128. For example, medications and cell/gene therapies can be added to modulate kidney function and/or immunologic function and provide for other therapeutic, research, and other functions.

In some embodiments, the organ preservation device 100 may include, or may be configured to operate in conjunction with, one or more therapeutics modules 128 designed to introduce, circulate, and/or remove pharmacologic agents, biologics, or cellular therapies within the perfusate during organ perfusion. The therapeutics module 128 enables the delivery of substances, such as medicines, nutrition, electrolytes and other substances that can modulate organ metabolism, repair mechanisms, vascular tone, or immune activation, thereby extending the viability of the organ and providing experimental or clinical treatments while the organ remains outside the body.

The therapeutics module 128 may include one or more infusion ports, injection manifolds, or peristaltic dosing pumps connected to the perfusate circuit at locations such as the outlet of the oxygenator 104, the inlet to the arterial cannula, or directly into the reservoir 116. These ports may accept syringe drivers, micro-pumps, or gravity-fed infusion bags containing therapeutic formulations, allowing precise and sterile introduction of small or continuous volumes of drug or reagent. Check valves may prevent backflow into the supply lines, and flow sensors may verify accurate dosing rates.

Therapeutic substances introduced via the module may include pharmacologic agents, such as vasodilators (e.g., prostaglandins, nitroglycerin), antioxidants, anti-inflammatory compounds, antibiotics, anticoagulants, and metabolic substrates (e.g., glucose, amino acids, or electrolytes). In some embodiments, pharmacologic agents may include cell-based therapies, including stem cells, endothelial progenitor cells, or immune regulatory cells, delivered in suspension or encapsulated form to repair or recondition injured tissue. In some embodiments, pharmacologic agents may include gene or RNA-based therapies, such as viral vectors, plasmid DNA, mRNA, or CRISPR/Cas gene-editing components, introduced through the perfusate to achieve localized transduction of renal cells or other organ parenchyma. In some embodiments, pharmacologic agents may include extracellular vesicle (EV) or exosome formulations, engineered to target specific receptors on the organ's vasculature or parenchymal cells for modulation of inflammation or immune response.

In some embodiments, the therapeutics module 128 may include multiple independent infusion channels, each capable of delivering a separate agent under software-controlled timing and concentration. The control system 126 may monitor perfusate parameters, such as pH, oxygen saturation, and perfusion pressure, and adjust therapeutic dosing automatically based on preprogrammed algorithms or feedback from sensor readings.

In some embodiments, the therapeutics module 128 of the organ preservation device 100 may include an infusion pump configured to deliver medications, nutrients, or other therapeutic agents into the perfusate with high accuracy. The infusion pump may operate in either bolus or continuous infusion modes, allowing rapid administration of discrete doses or sustained delivery over a defined period. The pump may be a syringe-type, peristaltic, or microgear pump controlled by the system controller 126 to regulate flow rate, infusion volume, and timing based on programmed protocols or sensor feedback.

In research embodiments, the therapeutics module 128 can support dose-response experiments, toxicity studies, or evaluation of new perfusion media by providing controlled and repeatable agent delivery. In clinical or translational settings, the module may enable organ-targeted preconditioning or ex vivo immunomodulation. For example, delivering complement inhibitors or anti-inflammatory biologics to reduce ischemia-reperfusion injury prior to transplantation.

The therapeutics module may be designed as a removable or disposable cartridge for sterile operation, or as an integrated subsystem mounted on the main device housing. All wetted components may be made from biocompatible, medical-grade materials such as silicone, polyethylene, polycarbonate, or stainless steel to prevent contamination or drug adsorption.

In some embodiments, closed-loop feedback control may be used in which the therapeutics module dynamically adjusts dosing based on measured biochemical or functional parameters of the organ, such as lactate clearance, oxygen consumption, urine production, or biomarker expression. This allows the organ preservation device 100 to function not only as a perfusion platform but also as a therapeutic bioreactor, capable of real-time organ conditioning, repair, and experimental manipulation under controlled physiologic conditions.

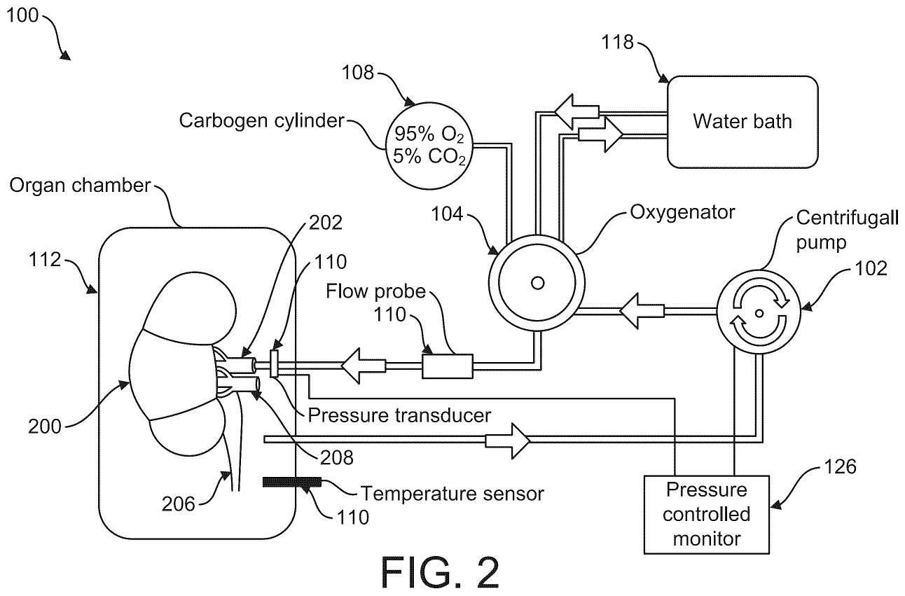

With reference to FIG. 2, a simplified system diagram of the system 100 is depicted. The depiction of system 100 of FIG. 2 includes the oxygenator 104 coupled in fluidic communication with the water bath, for temperature control, and a carbogen gas cylinder 108, for oxygenation. The oxygenator 104 is coupled in fluidic communication with the arterial inlet to the kidney, the renal artery 202, within the organ chamber 112. The vein outlet of the kidney, the renal vein 208 is open to the atmosphere in the organ chamber 112 to allow perfusate to exit the kidney 200 into the chamber 112 to flow to the inlet of the pump 102, which may be fluidically connected to the chamber 112, such as a drain of the chamber 112, and/or to a reservoir (not pictured in FIG. 2), to be recirculated via the pump 102. Urine produced by the liver may exit through the ureters 206 and may be collected by a urine collection system (not pictured in FIG. 2).

The simplified schematic of system 100 shown in FIG. 2 illustrates the principal functional relationships among the major components of the organ preservation device and highlights the continuous perfusion pathway during normothermic operation. In this configuration, the oxygenator 104 is positioned downstream of the pump 102 and upstream of the renal artery 202, forming the primary conduit for delivery of oxygenated and temperature-controlled perfusate to the organ 200 housed within the organ chamber 112.

The oxygenator 104 is shown coupled in fluidic communication with a water bath for thermal regulation and a carbogen gas cylinder 108 for oxygenation. The water bath provides continuous circulation of heated or cooled water around the oxygenator housing, allowing the perfusate temperature to be precisely maintained within a physiologic range prior to entry into the organ. The carbogen gas cylinder 108, containing approximately 95% oxygen and 5% carbon dioxide, delivers a regulated gas flow into the oxygenator through a gas inlet manifold controlled by the regulator 106. Within the oxygenator, the gas diffuses across semi-permeable hollow fibers, enriching the perfusate with oxygen and simultaneously removing carbon dioxide before the perfusate exits toward the arterial supply line.

From the oxygenator, the fully conditioned perfusate flows through the arterial conduit and enters the renal artery 202 through a canula, which supplies the vascular network of the kidney 200. The perfusate circulates through the microvasculature of the kidney, providing oxygen and nutrients to the tissue and supporting active metabolism under normothermic conditions.

The renal vein 208 is left open to the atmosphere within the organ chamber 112, allowing venous effluent to drain freely from the kidney. This open-circuit configuration reduces hydraulic resistance and simplifies pressure control, ensuring stable mean arterial pressure without requiring a separate venous return pump. The effluent perfusate accumulates in the base of the organ chamber 112, from which it flows by gravity and/or low-pressure suction to the inlet of the pump 102. Depending on the embodiment, the pump inlet may connect directly to a drain port at the bottom of the organ chamber or to a separate reservoir (not pictured in FIG. 2) that collects the returned perfusate. The pump 102 then recirculates the perfusate through the oxygenator 104, establishing a closed-loop or semi-open flow circuit.

During operation, the temperature controller associated with the water bath continuously monitors the perfusate temperature and adjusts heating or cooling output to maintain the desired thermal conditions. The regulator 106 maintains the gas flow rate and pressure from the carbogen cylinder 108, ensuring consistent oxygenation of the perfusate and maintenance of physiologic pH through controlled CO₂ content.

As the kidney 200 functions normally under these normothermic conditions, urine is produced and exits the kidney through the ureter 206, which may be connected to a urine collection device or reservoir (not depicted in FIG. 2). The urine collection system allows measurement of urine output, electrolyte concentrations, and biomarkers of renal function, providing a direct, real-time assessment of organ viability and performance.

In operation, the system 100 provides a continuous, physiologically representative circulation loop. The pump 102 establishes flow, the oxygenator 104 and water bath maintain oxygen and temperature homeostasis, and the open venous drainage ensures low resistance and stable hemodynamics. The controller 126 receives inputs from sensors measuring flow, pressure, and temperature throughout the circuit and can automatically adjust pump speed, gas flow, and heating or cooling power to maintain optimal perfusion parameters.

The organ preservation device 100 perfuses kidneys (or other tissue) ex situ (in a machine outside the donor or recipient body) with warm oxygenated blood/packed red blood cells (normothermic conditions) for organ preservation, allograft assessment, and potential modification prior to transplantation. This device warms, oxygenates, and circulates blood and additional components through the kidney to allow restoration of metabolic function, monitoring of perfusion characteristics, delivery of substances to alter blood flow or organ function (e.g. vasoactive medications, diuretics, parenteral nutrition), and monitoring and collection of urine output. Restoring metabolic function to kidneys ex situ allows functional assessment and allograft modification, potentially reducing organ discard and increasing kidneys available for transplant, improving post-transplant allograft and recipient outcomes, and prolonging organ viability prior to transplantation. The organ preservation device may be configured with an open circuit concept (e.g., renal artery is cannulated, renal vein is left open and perfusate effluent is collected in a central reservoir) to facilitate rapid and widespread clinical deployment. The organ preservation device is designed to be low cost for use in limited resource settings and without utilization. Maintenance of kidneys (or other organs) in a near-physiologic metabolically active state has other non-transplant applications including drug testing, pre-clinical research applications, combination with other ex situ machine perfusion devices for different organ types, and others.

The organ preservation device 100 may be used to deliver warm oxygenated blood under normothermic conditions to allow normal kidney metabolism and function to be assessed, substances delivered to alter perfusion and function, and improve allograft viability assessment and potentially post-transplant outcomes. Normothermic machine perfusion of hearts and livers has demonstrated improved outcomes. In situ normothermic kidney perfusion using normothermic regional perfusion has been shown to reduce kidney delayed allograft function. Early clinical trials of kidney normothermic machine perfusion have demonstrated non-inferiority compared to static cold storage.

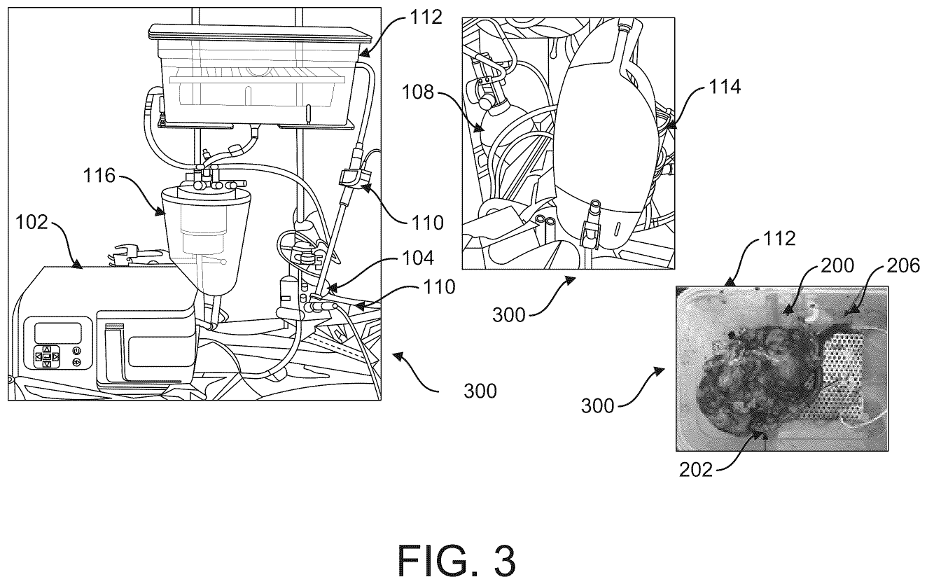

FIG. 3 depicts aspects of an experimental normothermic machine perfusion (NMP) device. The system includes an oxygenator 104 that includes a heat exchanger and may also include storage for the perfusate. The open-circuit design allows the venous outflow of the kidney to drain into a central reservoir 116, facilitating placement on the device. Small areas of bleeding or leakage of perfusate from the kidney do not need to be controlled, and perfusate circuit volume can be maintained without the need for an additional scavenger pump. A size E medical grade oxygen tank 108 supplies the oxygenator. To circulate the perfusate, a pump 102 was used to achieve the desired physiological flow rate of around 500 mL/min. Temperature control was achieved using an immersion circulator (not shown) heating a 2-gallon water bath in an insulated container the immersion circulator is capable of temperature adjustments in 1° C. increments. The water is then circulated into the heat exchanger in the oxygenator using a submersible pump to maintain the perfusate under normothermic conditions.

Temperature was measured using a resistance temperature detector (RTD) (Omega, Michigan City, Indiana). Pressure was measured with a Deltran® Disposable Pressure Transducer (Utah Medical, Midvale, Utah). Flow rate and temperature were measured with sensors 100. Flow rate was measured using a flow rate monitor and accompanying ultrasonic flow sensor. The flow rate monitor attaches to ⅜″ PVC tubing. A polycarbonate container 112 with dimensions 12.75″ L×10.5″ W×8″ H was prepared and modified to contain the organ, which rested on a removable, fenestrated silicone sheet. Various polycarbonate fittings, along with the PVC tubing were used to connect the components of the hydraulic circuit. A medical grade adhesive was used to adhere the connectors to the chamber.

The renal artery 202 was connected to the circuit via a custom-designed cannula with a 6 mm outer diameter. This cannula was 3D resin printed on an SLA printer. A double J ureteral stent was inserted into the ureter 206 and drained into a collection chamber 114.

In some embodiments, the renal artery 202 of the kidney 200 may be cannulated using an arterial connector assembly designed to provide a secure, atraumatic interface between the organ's vascular structure and the perfusion circuit. The cannulation assembly may include a custom-fabricated arterial cannula coupled to a quick-disconnect fitting that allows the kidney to be attached to or detached from the perfusion circuit rapidly and without loss of fluid or introduction of air.

The cannula may be configured to accept the native renal artery with an attached aortic Carrel patch, preserving the small section of donor aorta typically retained during organ procurement to maintain vascular integrity for subsequent transplantation. The Carrel patch allows for a more robust suture or clamp interface and reduces the risk of tearing or deformation of the arterial ostium during cannulation. The cannula may include a tapered insertion tip or barbed segment that fits snugly within the lumen of the Carrel patch, and may be secured by ligation, circumferential suture, or a compression collar to ensure a fluid-tight seal.

The proximal end of the cannula may terminate in a standardized luer, threaded, or quick-connect coupling, which mates with the arterial perfusion tubing from the pump-oxygenator circuit. This arrangement allows for priming of the circuit prior to organ attachment, allowing air to be removed and perfusate to be circulated through the tubing and oxygenator before connecting the organ. When the kidney is ready for perfusion, the quick-disconnect fitting is engaged, completing the flow path without interrupting perfusate circulation or introducing air bubbles into the line.

The cannula and fittings may be constructed of biocompatible, medical-grade materials such as polycarbonate or stainless steel. The internal geometry of the cannula may be configured to minimize turbulence and pressure drop. For example, in some embodiments, the cannula may provide for laminar flow into the renal artery and distributing perfusate evenly through the intrarenal vasculature. In some embodiments, the cannula assembly may include an integrated pressure sensor port or sampling port near the outlet to measure true arterial perfusion pressure immediately proximal to the renal artery.

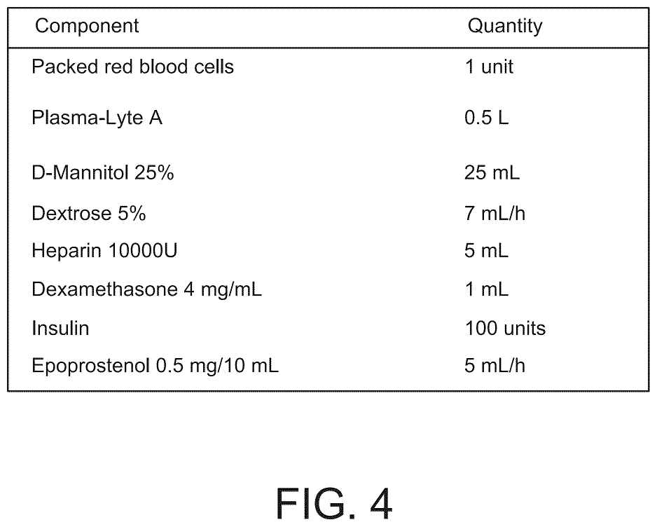

Expired type O (universal donor) packed red blood cells (pRBCs), were added to the perfusate as an oxygen delivery mechanism, consistent with clinical use. Electrolytes were added to the packed red blood cells. Calcium and sodium bicarbonate were administered based on point of care testing to achieve physiological levels. Heparin, mannitol, dextrose, dexamethasone, epoprostenol, and insulin were also added to the baseline perfusate composition. The perfusate is components where as shown in the table of FIG. 4.

Human kidneys recovered with the intention of transplantation but ultimately declined by all centers and approved for research donation, were used for these experiments. Organs were declined due to concerns for suitability for transplantation, including biopsy findings, warm ischemia time, cold ischemia time, and donor medical history. Organs were recovered using standard techniques and preserved in UW solution via static cold storage.

A point of care blood analyzer was used to evaluate physiologic endpoints during device operation. Two cartridges were used, a CG4+ and a CHEM8+ cartridge. The CG4+ cartridge provided metrics of pH and lactate, and blood gas measurements of pCO2, pO2, TCO2, HCO3, base excess (BEb), and oxygen saturation (sO2). The CHEM8+ cartridge provided hematocrit and electrolyte measurements of sodium, potassium, chloride, CO2, anion gap, ionized calcium (iCa), glucose (Glu), urea nitrogen (BUN), and creatinine.

Setting up the system included filing the reservoir with the perfusate solution and initiating the peristaltic pump was. The circuit prime was determined sufficient once steady flow rate was established in the arterial inlet connector. The perfusate was then gradually warmed to normothermic temperature over 30 minutes prior to kidney placement on the device.

The kidney was removed from its sterile packaging and kept cold in UW preservation fluid during preparation. The renal artery and vein were dissected free from surrounding tissue. Side branches were ligated. Excess fat surrounding the kidney was removed. The arterial cannula was placed into the renal artery and secured with a tie. The renal vein was intentionally left open, given the open-circuit design of the device. A double J stent was placed into the ureter and secured to allow for urinary quantification and analysis.

The arterial cannula was de-aired and connected to the device. The distal end of the ureteral stent was inserted into the urine collection reservoir. The kidney was placed within the device to ensure that there was no tension on the vascular pedicle and inspected to ensure that the renal artery was free of twists or kinks. Starting at a low flow rate of approximately 100 mL/min, pressure was monitored and resistance of the kidney was calculated. The pump flow rate was gradually increased until the desired flow rate of 500 mL/min was reached. The flow rate increase depends on the individual kidney characteristics and increases in pump speed occurred when the kidney was stabilized at the previous flow rate.

The kidney was continuously monitored for the duration of normothermic perfusion. Flow, temperature, and pressure were logged to ensure maintenance of physiological conditions over the duration of perfusion of a discarded human kidney. These parameters were adjusted according to kidney performance. The kidney was grossly examined for evidence of uniform perfusion. Urine output was monitored. Perfusate was serially sampled and monitored to ensure maintenance of adequate pH, oxygenation, and electrolyte composition.

Validation tests were conducted for each component to demonstrate the capabilities of the device under sustained operation. Data was collected in 5-minute intervals throughout the testing period.

Water was circulated through the device without a kidney to simulate the flow through the circuit. The pump flow rate was set to 1000 mL/min and ran for 1 hour. Pump flow rates were compared with the ultrasonic flow rate monitor. The test demonstrated the flow rate averaged at 1.08 L/min and varied around 0.10 L/min.

The thermoregulator for the water bath was set to 38° C. and the arterial perfusate temperature was measured and recorded. The mean perfusate temperature was 36.6° C., with a maximum temperature of 36.8° C. and a minimum temperature of 36.3° C.

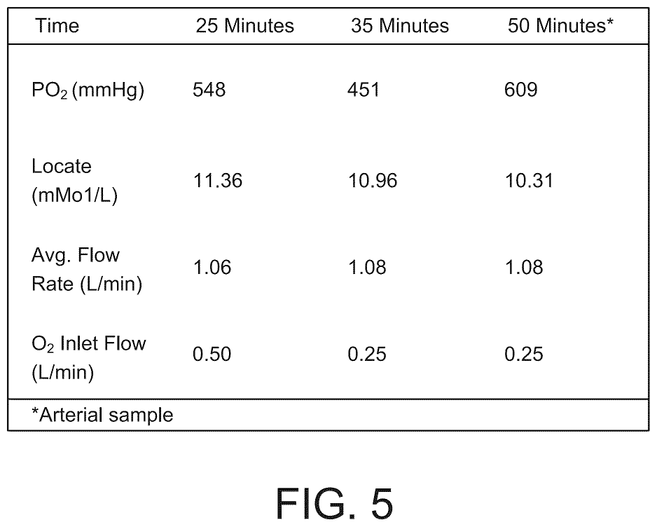

With the setup validated, further testing could be done using expired pRBCs to measure parameters related to oxygen carrying capacity of the perfusate. To evaluate the oxygen delivery of the system, pRBC-based perfusate was oxygenated using the circuit. pRBCs and Plasmalyte were used to simulate the final perfusate composition. Perfusate was sampled on the POC i-STAT device at three intervals during the experiment as depicted in the table of FIG. 5. Using an oxygen flow rate of 0.25 L/min, the perfusate demonstrated a PO2 of 400-600 mmHg. A final arterial sample was taken to determine the drop of partial pressure of oxygen in the perfusate between the arterial and venous lines. Average flow rates were measured from a 1-minute interval during each sampling instance.

In this setup, arterial temperature was continuously monitored and recorded. The temperature remained around 36.7° C. throughout the perfusion, with a maximum reading of 37.6° C. and a minimum of 36.1° C.

The device was tested using human kidneys declined for transplantation. The testing showed that the system can maintain kidney viability under normothermic oxygenated conditions for one hour in a device outside the body. The testing demonstrated maintenance of a consistent physiological flow rate of 500 mL/min and temperature of 37° C. during the 1-hour perfusion. The kidneys appeared pink and uniformly perfused. The index kidney produced 130 mL of urine over the duration of perfusion. Perfusate composition was monitored throughout the experiment using the point of care i-STAT device. This enabled real-time assessment of the perfusate characteristics and supplementation to maintain the appropriate physiological environment.

Testing shows that the NMP device could meet the physiological needs of a human kidney and demonstrated adequate device performance, kidney perfusion, and kidney function. The device validation tests demonstrated that the device could maintain physiological flow rates and temperature. The flow rate averaged 1.06 L/min, consistent with the input setting and without the resistance of a kidney. Even at double the nominal flow rate for the perfusion, the pump was shown to be capable of accurately generating the desired flow rate without tubing or circuit failure.

Physiological temperatures were maintained, averaging 36.7° C. while the thermoregulator was running. Serial perfusate sampling provided point of care insight into the biochemical conditions in the system. Using i-STAT CG4+ and CHEM8 assays, perfusate parameters were monitored in real time, including PO2 and lactate. Oxygenation was demonstrated to be adequate, with PO2 at 451 mmHg at a modest 0.25 L/min flow rate of oxygen.

Testing also shown that the device was able to maintain physiological parameters for kidney function. The results show that even with a suboptimal kidney that was declined for transplantation, perfusion on the device enabled uniform perfusion with adequate flow and pressure.

The kidney produced urine, an important marker indicating proper kidney function. The red tinge in the urine indicated the presence of blood in the urine. Hematuria (blood-tinged urine) is a relatively common occurrence after kidney transplantation. Potential causes include mild trauma to the urine collecting system during stent insertion or a small amount of bleeding from the cut edge of the ureter. Hematuria after kidney transplantation is usually self-limited. The degree of hematuria seen in this study was mild.

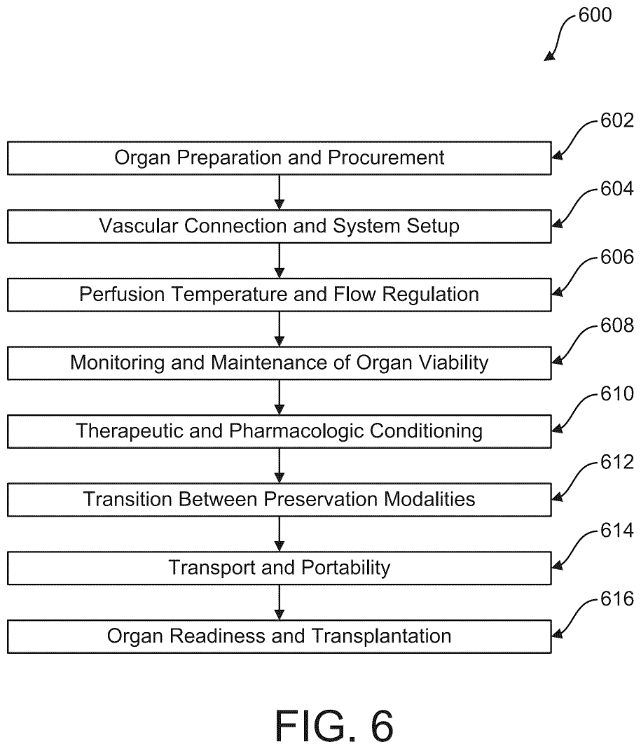

FIG. 6 depicts a method 600 for organ transplantation. In some embodiments, the method for transplantation 600 may be implemented using the organ preservation device 100 to support, preserve, and prepare a kidney or other organ for transplantation. The method may include one or more of the following steps, which may be performed in sequence or in part, depending on the organ type, preservation modality, and clinical application.

In step 602, a donor kidney or other transplantable organ is surgically procured from a donor and placed in a preservation solution or on ice to limit warm ischemic time. The renal artery, renal vein, and ureter are isolated. In some embodiments, the renal artery may induce an aortic Carrel patch retained around the arterial ostium when possible to preserve the integrity of the vascular structure for subsequent cannulation and eventual surgical anastomosis.

In some embodiments, vascular reconstruction may be performed at this stage, such as the use of vascular graft material to repair or extend the renal artery or vein, or to join multiple arterial branches into a single common inflow for perfusion. The prepared organ may then be transferred to the organ chamber 112 of the system 100 for connection to the perfusion circuit.

In step 604, arterial, venous, and ureteral connections are established, and the perfusion circuit is primed for operation. The renal artery may be cannulated using one or more of several available techniques, such as direct renal artery cannulation with a size-appropriate cannula, a clamp-based connector designed to preserve the aortic Carrel patch, or a Y-connector system allowing simultaneous cannulation and perfusion of kidneys with multiple renal arteries.

In some embodiments, vascular grafts or other custom connectors may be used to accommodate variations in donor anatomy.

The renal vein may remain open to the atmosphere within the organ chamber 112, permitting free venous drainage of perfusate into the chamber and subsequently to the reservoir 116. The ureter may be cannulated using a small catheter or stent connected to the urine collection device 114, allowing urine to be collected for measurement and analysis or recirculated to the reservoir 116.

The perfusion circuit may be primed with the selected perfusate, which may include whole blood, packed red blood cells, hemoglobin-based oxygen carriers, or colloid/crystalloid-based solutions, and lines are de-aired to prevent gas embolism. The operator or control system verifies system readiness, including proper operation of the pump 102, oxygenator 104, heat exchanger 120, temperature controller 124, sensors, and controller 126. Perfusion may be initiated at low flow and pressure while vascular integrity is determined based on sensor data, such as by the absence of leaks (flow in is within a threshold difference of flow out), before progressing to full perfusion.

In step 606, the temperature and flow of the perfusate are controlled through the controller 126, which receives input from temperature, pressure, and flow sensors positioned throughout the circuit. The heat exchanger 120 and water bath 118 regulate perfusate temperature to achieve the desired preservation condition, such as hypothermic (4-10° C.), sub-normothermic (20-32° C.), or normothermic (35-38° C.) perfusion. The temperature of the perfusate and the chamber 112 may be ramped from an initial temperature to the desired temperature for hypothermic (4-10° C.), sub-normothermic (20-32° C.), or normothermic (35-38° C.) perfusion.

The pump 102 may be adjusted to provide physiologic flow and pressure, which may be continuous or pulsatile depending on the chosen mode of operation. Flow dynamics may be further refined by modifying tubing stiffness or external compression, allowing simulation of physiologic systolic and diastolic pressure profiles. The oxygenator 104, supplied with gas from the carbogen cylinder 108 via the regulator 106, maintains appropriate oxygenation and acid-base balance of the perfusate.

In step 608, perfusion parameters and organ viability are monitored using the system's integrated sensors and control software. Measurements of pressure, flow, temperature, oxygen concentration, and urine output are displayed in real time on the display interface of the controller 126, allowing the operator to observe trends and make adjustments as needed.

Optional remote monitoring and video feed may be employed to permit continuous supervision of perfusion conditions from a remote location. Automated feedback loops within the control system may adjust pump speed, gas flow rate, and heating or cooling output to maintain perfusion within predefined ranges.

Throughout this step, urine production, perfusate composition, and organ color or turgor may be assessed as direct indicators of renal viability and function.

In step 610, the organ may be exposed to pharmacologic, cellular, or genetic therapies to improve function or reduce injury. Medications, nutrients, or biologic agents may be administered through the therapeutics module 128 or via the precision infusion pump, which may deliver agents in either bolus or continuous infusion modes.

Therapies may include antioxidants, vasodilators, anti-inflammatory compounds, or oxygen-carrying supplements. In some embodiments, gene or cell-based therapies, including extracellular vesicles, viral vectors, or stem cells, may be introduced to promote tissue repair or modulate immune response. The controller 126 may regulate dosing automatically in response to perfusate parameters such as pH, lactate, or oxygen saturation.

This step may be conducted under any temperature modality and may also be used for preconditioning the organ prior to implantation.

In some embodiments, at step 610, kidneys exhibiting ischemic or metabolic injury may be treated directly on the device through the targeted delivery of therapeutics using the therapeutics module 128. Agents including small molecules, stem cells, stem cell-derived products (such as extracellular vesicles or exosomes), and conventional medications may be infused into the perfusate via the precision infusion pump to modulate renal function and initiate repair processes. These therapies can reduce oxidative stress, inflammation, and endothelial injury, while promoting cellular regeneration and improving perfusion uniformity. Controlled dosing and feedback monitoring through the controller 126 allow dynamic adjustment of therapeutic exposure to maximize recovery without systemic toxicity. By enabling active resuscitation of injured kidneys prior to transplantation, the system enhances both immediate graft function and long-term transplant success.

In step 612, the organ preservation device 100 may be utilized to transition the perfused organ between different perfusion modalities, including hypothermic machine perfusion (HMP), sub-normothermic perfusion, and normothermic perfusion (NMP). These transitions may be performed in a controlled, gradual manner to maintain physiologic stability and minimize stress on the organ tissue.

The controller 126, in conjunction with the heat exchanger 120, temperature controller 124, and water bath 118, regulates the temperature of the perfusate according to a programmed or operator-defined temperature ramp. For example, following cold static storage or initial hypothermic perfusion at approximately 4-10° C., the temperature may be slowly increased to a sub-normothermic range of about 20-30° C., and then further increased to the normothermic range of about 35-38° C. The heating rate may be linear or stepwise and may include dwell periods at intermediate temperatures to allow the organ to equilibrate and maintain metabolic stability.

In some embodiments, the system may also facilitate controlled cooling, for instance, following normothermic perfusion, the temperature may be gradually reduced to sub-normothermic or hypothermic levels for storage or transport. In each case, the system's temperature sensors provide real-time feedback to the controller, which automatically adjusts heater power or coolant circulation to achieve precise temperature control.

In some embodiments, the system may also facilitate controlled rewarming back to normothermic perfusion, the temperature may be gradually increased to normothermic conditions wherein the organ may be monitored by the sensors and evaluated for suitability for implantation. In each case, the system's temperature sensors provide real-time feedback to the controller, which automatically adjusts heater power or coolant circulation to achieve precise temperature control.

Throughout these transitions and/or at each temperature regime, the other steps of the method for transplantation 600, such as, Step 606, Step 608, and Step 610, may occur.

For example, during rewarming from hypothermic to normothermic perfusion, Step 606 may be active to dynamically adjust pump flow, pressure, and oxygenation parameters to match increasing metabolic demand. Step 608 may continue uninterrupted to monitor real-time changes in perfusion pressure, oxygen consumption, and urine production as the organ warms and resumes full physiologic function. Likewise, Step 610 may be performed before or during temperature transitions to introduce pharmacologic or metabolic agents that support reperfusion, enhance recovery, or prevent ischemia-reperfusion injury.

This coordinated integration of steps allows the system 100 to support multi-phase preservation workflows in which an organ may undergo initial hypothermic perfusion for transport, sub-normothermic perfusion for gradual metabolic recovery, and final normothermic perfusion for viability assessment and therapeutic conditioning prior to transplantation. The transition between modalities enables continuous preservation without interruption of perfusion, oxygenation, or monitoring, thereby maintaining organ viability across the full preservation and transplantation continuum. In some embodiments, a method for organ investigation 700 may be implemented using the organ preservation device 100 to study, characterize, or validate perfusion, metabolic function, and physiologic responses in excised organs or tissue models. This method may be applied to a wide variety of biological specimens, including kidneys, vascular segments, and composite tissue flaps, and may be adapted for both research and diagnostic use.

At Step 616, the organ preservation device 100 and method for transplantation 600 may be used to perform viability assessment of the perfused kidney prior to transplantation. Continuous monitoring of perfusion pressure, flow, oxygen consumption, and urine production provides direct indicators of vascular integrity and metabolic function. Additional biochemical and molecular assays, such as measurement of lactate clearance, creatinine levels, or ATP content, can further quantify viability. This in situ assessment enables identification of kidneys that demonstrate impaired perfusion, limited metabolic recovery, or poor functional parameters, allowing clinicians to avoid transplantation of marginal organs that would otherwise result in suboptimal graft outcomes or early graft loss.

In some embodiments, method 600 may also include, for example, for studying ischemia-reperfusion injury (IRI) and immunologic responses under physiologic conditions. The kidney may be intentionally subjected to defined ischemic intervals by temporarily halting perfusion, followed by reperfusion with oxygenated perfusate to model post-transplant reoxygenation injury. Biomarkers of oxidative stress, cytokine release, and endothelial activation may then be measured in the perfusate to quantify injury severity. Likewise, the system may be used to evaluate immunologic responses by perfusing the organ with autologous or allogeneic blood or immune cell-containing perfusate. This setup allows characterization of antigen presentation, complement activation, and leukocyte adhesion events ex vivo, providing mechanistic insight into post-transplant rejection and tolerance phenomena.

In some embodiments, at step 616, the device and method can facilitate biomarker discovery and validation for predicting post-transplant graft function. Continuous sampling of the perfusate and urine during perfusion allows measurement of both established and novel molecular markers, including lactate, NGAL, KIM-1, IL-18, and other injury-associated proteins, that correlate with renal recovery or dysfunction. Advanced analytic approaches, such as proteomic or metabolomic profiling, may be integrated into the workflow to identify additional predictive signatures. The controlled and reproducible environment of the organ preservation device 100 allows direct correlation between biomarker levels and functional outcomes, accelerating discovery of diagnostic tools to predict graft performance before implantation.

In some embodiments, at step 616, the perfusate may be switched to whole blood or a blood-based solution to simulate in vivo transplantation and evaluate the kidney's physiologic response under near-clinical conditions. This transition enables assessment of the organ's ability to handle full oxygen-carrying capacity, metabolic load, and hemodynamic stress comparable to that encountered after reperfusion in the recipient. Parameters such as vascular resistance, urine output, oxygen consumption, and acid-base balance can be measured in real time. The response to whole blood perfusion provides a dynamic functional stress test that predicts post-transplant performance and helps determine the optimal timing for transplantation. This capability transforms the system into a comprehensive ex vivo assessment platform bridging preservation and transplantation readiness.

In step 702, the selected tissue or organ model may be prepared for connection to the perfusion system. The specimen may include a whole organ, such as a kidney or segment of vascular tissue, or a composite tissue flap, such as a pedicled or myocutaneous flap, used in skin, wound-healing, or reconstructive research. The tissue or organ may be freshly excised or preserved using an appropriate storage medium prior to perfusion.

Relevant vascular structures, including arteries, veins, or vascular pedicles, may be isolated and preserved to maintain physiologic architecture. In some embodiments, vascular reconstruction or grafting may be performed to facilitate cannulation. The prepared tissue is then placed within the organ chamber 112 of the device 100, where it rests on the soft, fenestrated platform to permit drainage of perfusate to the reservoir 116.

In step 704, the arterial supply of the organ or tissue model is connected to the arterial line of the perfusion circuit, which includes the pump 102, oxygenator 104, and associated tubing. The arterial connection may be established using a custom cannula, clamp-based system, or other connector appropriate to the vessel size and configuration.

The venous outflow may remain open to the chamber atmosphere to allow drainage by gravity, or it may be connected to the reservoir 116 to form a closed or semi-closed circuit. The ureteral connection step used for kidney models may be omitted or modified as required for other tissue types.

Prior to initiating flow, the circuit is primed with an appropriate perfusate selected for the specific tissue or experimental objectives. The perfusate may include whole blood, packed red blood cells, hemoglobin-based oxygen carriers (HBOCs), or synthetic colloid/crystalloid solutions containing electrolytes, nutrients, and buffering agents. The circuit is de-aired, and flow is initiated at low pressure to verify the integrity of vascular connections and confirm adequate inflow and drainage.

In step 706, the controller 126 is used to regulate and tune perfusion parameters to suit the specific tissue model under investigation. The pump 102 may be configured for continuous or pulsatile operation, and the flow rate, pressure, and temperature of the perfusate may be varied over a broad range.

For vascular models, perfusion may be tuned to mimic arterial pulse waves, while for composite tissue flaps or skin models, lower pressures and continuous flow may be used to maintain viability without vascular damage.

In step 708, the functional and physiologic performance of the tissue or organ model is evaluated. The sensors 110 integrated into the perfusion system continuously monitor flow, pressure, temperature, oxygenation, and perfusate composition. Data are transmitted to the controller 126, which logs and displays real-time measurements for analysis.

In kidney models, perfusion dynamics can be measured to validate flow distribution within the renal vasculature, including assessment of perfusion homogeneity and vascular resistance. For vascular or flap models, data may be used to quantify flow-pressure relationships, tissue oxygen consumption, or microvascular patency.

Samples of perfusate or tissue may be collected during or after perfusion for biochemical, molecular, or histologic evaluation.

In step 710, the organ preservation device 100 may be integrated with external diagnostic and imaging technologies for real-time organ or tissue assessment. These modalities may include: ultrasound imaging for evaluation of perfusion, vascular flow patterns, and tissue structure, Indocyanine green (ICG) fluorescence imaging for microvascular visualization and perfusion mapping, optical or fluorescent imaging systems for detecting metabolic or viability markers, and/or infrared or near-infrared cameras for thermal and blood-flow analysis.

The imaging systems may be mounted externally or integrated into the organ chamber 112, enabling synchronized acquisition of imaging data with perfusion parameters from the controller 126. This multimodal integration allows correlation of physiologic data with visual evidence of perfusion, tissue oxygenation, and metabolic activity, enhancing assessment of organ viability and experimental outcomes.

In step 712, pharmacologic agents, dyes, or biologic materials may be administered through the therapeutics module 128 or precision infusion pump to test experimental hypotheses or simulate clinical scenarios. The infusion system may deliver agents in bolus or continuous modes under software control.

Examples include the addition of vasoactive compounds, angiogenic factors, fluorescent tracers, or cytoprotective agents. The system may also be used to study the effects of ischemia and reperfusion by temporarily halting and reinitiating perfusion under defined conditions.

For gene-or cell-based studies, the therapeutics module may introduce cell suspensions, extracellular vesicles, or gene-editing constructs into the perfusate to observe their distribution and effects in the perfused tissue. These interventions can be timed and monitored using the system's integrated sensors and data acquisition capabilities.

In step 714, data generated during perfusion, including flow metrics, sensor outputs, and imaging results, are collected and analyzed using the controller 126 and, optionally, external analytical software. The controller may export data in real time for integration with computational models of organ perfusion or vascular flow dynamics.

For kidney investigations, the measured flow and pressure data can be compared to computational or physical kidney vasculature models to validate simulated hemodynamics. In tissue flap or vascular studies, imaging and sensor data can be correlated to determine optimal perfusion conditions, evaluate response to therapies, or characterize tissue recovery.

While the organ or tissue with within the chamber 112, the device 100 may be used to carry out other tasks on the organ or tissue, such as part of one or both of methods 600 and 700. For example, at blocks 606, 608. 610, and 612 of method 600 and 706, 708, 710, 712, and 714 of method 700.

The organ preservation device 100 may serve as a controlled experimental platform for modeling hemodynamics and validating the efficacy of vascular or biochemical sensor technologies. The system's ability to precisely regulate perfusate flow, pressure, and pulsatility allows accurate replication of physiologic or pathologic vascular conditions in isolated organs or tissue models. Sensors measuring flow, pressure, oxygenation, and metabolic parameters can be integrated directly into the circuit or applied externally to the organ, permitting real-time comparison and calibration under known perfusion conditions. This enables development and benchmarking of new diagnostic sensors, flow probes, or imaging modalities in a reproducible and physiologically relevant environment.

Because the organ is maintained as a metabolically active yet isolated system, the device 100 enables administration of pharmacologic agents, biologics, or gene-editing technologies directly into the perfusion circuit without exposing a transplant recipient or donor to potentially toxic systemic doses. Therapeutic interventions, including novel drugs, CRISPR-based gene-editing constructs, viral vectors, or nanoparticles, can be tested or applied within the ex vivo organ environment, avoiding off-target effects in other tissues. This localized delivery allows precise evaluation of efficacy and safety in a fully functional organ prior to transplantation, thereby reducing clinical risk and enabling preconditioning or genetic modification while preserving transplant suitability.

The system 100 allows controlled exposure of the organ to therapeutic or genetic interventions that can induce either transient or durable modifications. Short-term or reversible treatments, such as pharmacologic preconditioning, antioxidant therapy, or anti-inflammatory infusions, can be used to enhance early graft function or reduce ischemia-reperfusion injury. Alternatively, long-lasting modifications may be achieved through stable gene transfer, protein expression, or cellular engraftment using the device's therapeutics module 128 and precision infusion systems. These controlled manipulations allow the organ to be functionally optimized prior to transplantation, ensuring improved immediate performance and potentially extending graft longevity.

The organ preservation device 100 provides a unique platform for immunologic modulation of donor organs before transplantation. Using targeted perfusate formulations or gene-editing tools, the expression or surface density of ABO blood group antigens, human leukocyte antigens (HLA), or other immunoregulatory molecules can be selectively enhanced or suppressed. This modulation can be temporary, reducing immune recognition during early post-transplant periods, or permanent, creating a durable alteration in the organ's antigenic profile. By controlling perfusion parameters, temperature, and exposure time, the system enables precise tuning of immunologic activity, thereby mitigating rejection risk and expanding donor-recipient compatibility.

The device 100 may be employed to study and therapeutically modulate cellular responses to inflammation, oxidative stress, and tissue injury in real time. The therapeutics module 128 and precision infusion pump enable delivery of small molecules, stem cells, or stem cell- derived products such as extracellular vesicles or exosomes directly into the perfusate. These agents can attenuate pro-inflammatory pathways, enhance antioxidant capacity, and stimulate regenerative signaling cascades. Continuous monitoring of perfusate chemistry, flow, and oxygenation allows quantitative assessment of the organ's response to such interventions, providing a powerful model for evaluating therapeutic strategies that promote tissue protection and repair.

In some embodiments, multiple organ preservation devices 100 may be connected in series or parallel configurations to model systemic physiology or improve preservation conditions during extended perfusion. This approach may be particularly advantageous for addressing fluid overload and tissue edema encountered during long-term normothermic perfusion of organs such as the heart, liver, or lungs. By linking multiple organs within a shared or cross-circulating perfusion network, the system can reproduce inter-organ metabolic exchange and maintain more physiologic osmotic and fluid balance. Such interconnected systems may support more stable perfusion pressures, improved oxygen utilization, and extended viability during prolonged ex vivo maintenance or experimental co-perfusion studies.

The above examples and disclosure are intended to be illustrative and not exhaustive. These examples and description will suggest many variations and alternatives to one of ordinary skill in this art. All these alternatives and variations are intended to be included within the scope of the attached claims. Those familiar with the art may recognize other equivalents to the specific embodiments described herein which equivalents are also intended to be encompassed by the claims attached hereto.

What is claimed is:

1. A system for ex vivo normothermic organ preservation, the system comprising:
a pump configured to circulate a perfusate through a perfusion circuit;
an oxygenator coupled in fluid communication with the perfusion circuit and configured to oxygenate the perfusate;
a heat exchanger configured to regulate a temperature of the perfusate within the perfusion circuit;
an organ chamber having an internal volume configured to receive an organ and having a perfusate outlet open to the internal volume of the chamber and in fluid communication with the perfusion circuit, and wherein the perfusion circuit is configured to be coupled in fluid communication with an arterial inlet into the organ;
a processor; and
memory comprising instructions that when executed by the processor cause the system to carry out a method, the method including:
changing a temperature of the perfusate from an initial temperature to a normothermic temperature within a normothermic temperature range;
maintaining the perfusate within the normothermic temperature range for at least one hour;
receiving sensor data for perfusate parameters; and
displaying the sensor data.

2. The system of claim 1, wherein the perfusion circuit is configured to not be in direct fluid communication with a venous outlet of the organ.

3. The system of claim 1, wherein the perfusion circuit is configured to receive venous output of the organ from the internal volume of the chamber.

4. The system of claim 1, further comprising a urine reservoir configured to receive urine from within the chamber.

5. The system of claim 1, further comprising a urine reservoir configured to be in fluid communication with an ureters of the organ.

6. The system of claim 1, further comprising a urine reservoir configured to be in fluidic communication with the perfusion circuit.

7. The system of claim 1, wherein the pump is configured to operate in a pulsatile mode to generate systolic and diastolic pressures within the perfusion circuit.

8. The system of claim 1, wherein the organ chamber further comprises a fenestrated platform configured to support the organ and permit drainage of perfusate through the fenestrated platform and to the perfusate outlet.

9. The system of claim 1, further comprising a therapeutic module configured to provide one or more therapeutic agents into the perfusate circuit.

10. The system of claim 9, wherein the one or more therapeutic agents comprise a small molecule drug, antioxidant, vasodilator, anti-inflammatory compound, stem cell, stem cell-derived product, viral vector, or gene-editing construct.

11. The system of claim 1, wherein the method further comprises:
providing an indication of organ viability based on the sensor data after at least one hour within the normothermic temperature range.

12. The system of claim 1, wherein the initial temperature is within a hypothermic temperature range between approximately 4° C. and 10° C.

13. The system of claim 1, wherein the normothermic temperature range is between approximately 35° C. and 38° C.

14. The system of claim 1, wherein maintaining the perfusate within the normothermic temperature range for at least one hour includes maintaining the perfusate within the normothermic temperature range for at least four hours.

15. The system of claim 1, wherein the method further comprises changing the temperature of the perfusate from the normothermic temperature to a hypothermic temperature.

16. The system of claim 1, wherein the method further comprises measuring parameters of urine collected from the organ.

17. The system of claim 1, wherein the parameters of the urine include a urine flow rate.

18. The system of claim 1, wherein the parameters of the urine include kidney viability markers.

19. The system of claim 11, wherein the indication indicates that the organ is in a range of non-viability or undetermined viability.

20. The system of claim 19, method further comprising:
providing therapeutics into the perfusate after indicating that the organ is in the range of non-viability or undetermined viability;
receiving, after providing therapeutics, second sensor data for perfusate parameters; and
indicating that the organ is in a range of variability based on the second sensor data.
